(19) United States
(12) Patent Application Publication
(10) Pub. No.: US 2011/0101626 A1
(43) Pub. Date: May 5, 2011

(54) FLAT SEAL

(75) Inventors: Rolf Prehn, Wipperfurth (DE); Theofilos Chatziioannidis, Dusseldorf (DE); Rainer Capellmann, Burscheid (DE)

(73) Assignee: FEDERAL-MOGUL SEALING SYSTEMS GMBH, Herdorf (DE)

(21) Appl. No.: 13/000,507

(22) PCT Filed: Jun. 19, 2009
(86) PCT No.: PCT/DE2009/000842

§ 371 Date: Dec. 21, 2010

(30) Foreign Application Priority Data
Jun. 21, 2008 (DE) 10 2008 029 543.4

(51) Int. Cl. F02F 11/00

(52) U.S. Cl. 277/592; 277/594; 277/593; 277/598

(57) ABSTRACT

The invention relates to a flat seal, in particular a cylinder head gasket or an exhaust flange seal, comprising at least one layer provided with at least one through opening. The through opening receives at least one elastically deformable profiled body configured as an annular profile wire, having a defined material thickness. The total height of the non-deformed profiled body is greater than the thickness of the layer, and the layer is provided at least partially with material thickening in the region of the profiled body and/or outside of the profiled body.

The invention relates to a flat gasket, in particular to a cylinder head gasket or an exhaust flange gasket.

It is known for the cylinder head gaskets, which consist of several (metal) layers, how to connect to each other the layers, which, when necessary, can be differently built, by using appropriate joining technologies (e.g. clinching, welding). With the help of the so-called stopper members, which are built with additionally inserted rings, layers or stampings, the necessary height difference at the combustion chamber edge is adjusted to the edge surface area of the flat gasket.

A gasket configuration for a combustion engine can be taken from EP 0 538 628 A2, which contains a cylinder head, a motor block and a cylinder liner inserted in a drilled hole of the motor block and supported by it, a hollow cylindrical part, a sealing collar in the form of a ring stretching radially outwards from the cylindrical part, a piston bore and a collar joint surface essentially pointing to the cylinder head and containing further sealants which are engaged with the collar joint surface and a corresponding cylinder head sealing surface in order to prevent the escape of combustion gases from the piston bore. At least one of the two sealing surfaces is built in a frustroconical form and is extending continuously from a radially internal circumferential area to a radially external circumferential area, whereby the radially internal circumferential area is spaced apart farther from the other sealing surface than the radially external area.

The task of the invention is to propose a new sealing concept for flat gaskets in which profile elements that can function as a sealing element are used.

Another objective is to permit the targeted adjustment of the force distribution not only in the sealing system, but also in the remote periphery (hinterland) of the flat gasket which, as a rule, is determined by bolt forces.

The task is solved by means of a flat gasket, in particular a cylinder head gasket or an exhaust flange gasket, containing at least one layer provided with at least one through opening, whereby the through opening receives at least one elastically malleable profile element built as a profile wire with a ring form and with defined material thickness, whereby the full height of the undeformed profile element is larger than the thickness of the layer, and the layer in the area of the profile element and/or outside of the profile element is provided at least partially with material compression.

Other advantageous implementations of the object of the invention are provided in the subclaims.

The material compression can be provided depending on the implementation form by stamping or by adding a coating.

Also combined material compression (stamping+coating) is possible, as well as the applying of a stopper.

If the material compression is built with a coating, a polymer, in particular a thermoplastic or duroplastic material, can offer the same advantages.

It can be advantageous also when the coating contains particles and/or fibers. To this purpose, both metal and also mineral particles can be used individually or in combination, whereby the particles and/or the fibers should have certain thickness.

According to another idea of the invention, the coating can be applied over the respective area of the layer by screen printing.

The material compression can be applied on defined locations along the sections of the layer surrounding the through opening or be applied in such a way that a closed area with a wall thickness that can be specified is built.

It is of a particular advantage that the profile element, seen in radial direction, is built with areas of different material thickness. For example, here the cross section has the form of a banana in which the thickness of the material is largest in the middle area of the radial extension of the profile element and then decreases towards the peripheral areas. In this way, a central core area and an outside elastically deformable area are formed.

The profile body can be either partially connected at least partially with the layer or positioned in the through opening in a radially mobile manner.

It is of a particular advantage that material compression is provided also outside of the profile element. Here we have in mind the so-called hinterland which extends up to the edge areas of the flat gasket. The respective material compression can be provided partially or over larger surface areas in the hinterland and can, if needed, enclose at least partially the bolt through openings.

In this way, an optimal force distribution within the entire gasket can be ensured which affects positively the sealing behavior.

The purpose of the controlled adjustment of the force distribution, in particular the division between the profile element and the layer sections connected to it, is achieved, for example, by means of the height differences between the combustion chamber sealing and the media sealing. If the media sealing and the combustion chamber sealing have the same height (additional precondition: the used seals show the same tightness and rigidity), it can be proceeded from an equal load distribution. If the heights of the media sealing and the combustion chamber sealing are different, higher load can be partially generated. However, in order, for example, that the combustion chamber sealing could take over a higher portion of the bolt forces, it is worked with a supernatant of the combustion chamber sealing. This means that the combustion chamber sealing must be higher than the media sealing.

The height difference between the combustion chamber sealing and the media sealing can be adjusted precisely by means of applying flat or partial material compression on the layer. In this way, both the necessary and also topographic height differences can be implemented in order that, for example, to increase or decrease deliberately the hinterland (for example, by means of coatings with different materials and different particle sizes).

The object of the invention is presented in the figure and will be described in more details further below. The figure shows the following items:

FIG. 1 Schematic cylinder head gasket with a single-sided shaped layer as material compression;

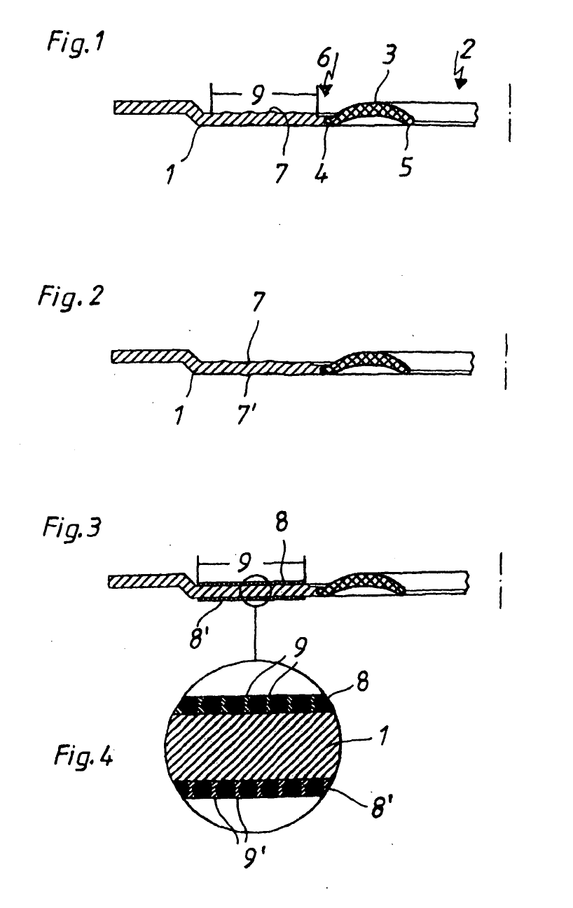

FIG. 2 Schematic cylinder head gasket with a polymer coating as material compression;

FIG. 3 Schematic cylinder head gasket with a single-sided shaped layer as material compression;

FIG. 4 Detail enlargement based on FIG. 3;

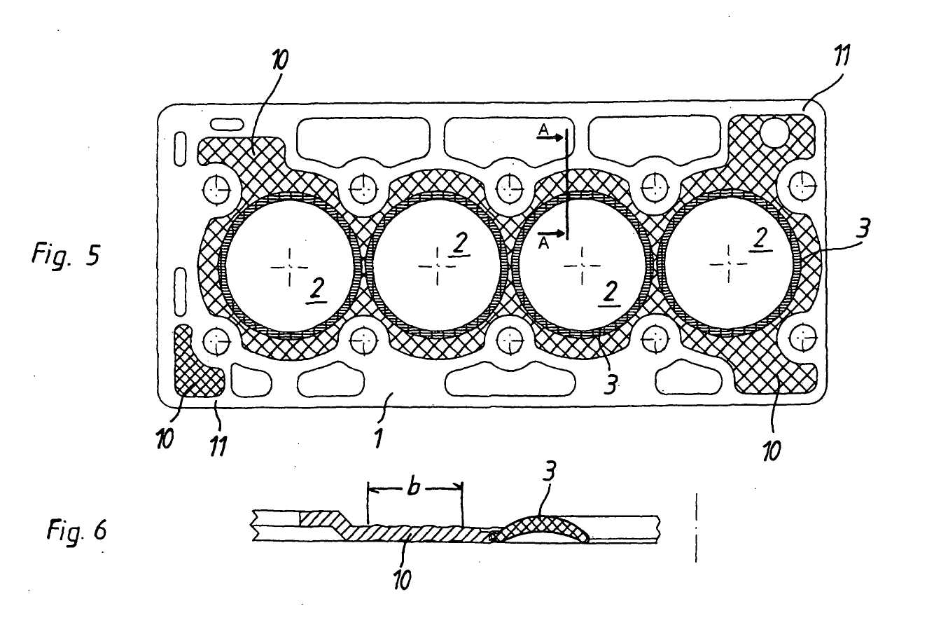

FIG. 5 Top view of a cylinder head gasket built as flat gasket with material compressions on selected areas;

FIG. 6 A cross section along the A-A line in FIG. 5.

FIG. 1 shows only a schematic representation of a cylinder head gasket containing at least one layer 1 containing at least one through opening 2. The layer 1 designed here as a metal layer acts together with a profile element 3 with the form of a ring and built as profile wire which, seen in radial direction, is designed in the form similar to a banana. The middle area of the profile element 3 forms the area of the largest thickness of the material which decreases—forming bending areas—towards the ends 4, 5. In this example, the radially external end 4 of the profile element 3 is connected in a form-locked way (for example by caulking) with the opposite section 6 of the layer 1. The full height of the undeformed profile element 3 exceeds the thickness of the layer 1. In order to achieve a defined force distribution within the cylinder head gasket, which, as a rule, is caused by the bolt forces, a partial area of the layer 1 is supplied with material compression. In FIG. 1, the material compression is formed by a single-side embossed region 7.

FIG. 2 should be seen as analog to FIG. 1, whereby here two embossed regions 7, 7′ are provided in the area of the layer 1. The corresponding arrangements of the embossed regions 7, 7′ offer the advantage that the height differences can be adjusted very precisely. In this way, both the necessary height differences as well as topographic ones can be set up. This means that the adjustment of the height differences is performed through the heights (or the depths) of the embossing 7, 7′. The layer 1 can be embossed in different ways. Semi-spherical (indentation), rectangular or also ring-shaped (beads) embossings.

FIG. 3 shows a variant of the FIGS. 1 and 2, whereby also here an area a with material compression is provided which in this implementation form is built by means of two-sided coating 8, 8′ with defined thickness of the material. The coating 8, 8′ consists of a polymer, in particular of thermoplastic or duroplastic material. By the addition of metal, ceramic or mineral particles or fibers with a relatively narrow particle size distribution or thickness tolerance, which corresponds exactly to the height difference to be adjusted, different heights can be set up very precisely. Even when the polymer is degraded due to temperature influence, the particles, which take over the distance function, still ensure the height difference.

The polymer must contain only a certain portion of particles and fibers which depends on the particle size (the larger the particles are, the higher their portion has to be).

Analogically to FIGS. 1 and 2, the coating 8, 8′ can be both single-side and two-side.

FIG. 4 shows a detail enlargement based on FIG. 3. The layer 1, as well the coatings 8, 8′ applied on both sides, can be identified. The respective coating 8, 8′ can be applied by using a screen printing method. In order that the particles or the fibers 9, 9′ could correspond to the height difference to be set up, it must be ensured only that all particles or fibers 9, 9′ lie in one plane.

Not shown but included in the protection scope is the point that the respective layer can be provided in a single-sided or double-sided plated form (e.g. aluminum), whereby the material compression can be obtained, for example, by embossment of at least one plated area (in the plating only).

By the use of material compressions either in the layer or in a plated layer, it is possible to prepare specified topographies both in height as well as in width.

FIG. 5 shows in top view a cylinder head gasket designed as a flat gasket. The same components have the same reference designations as in the FIGS. 1 to 4. In this example, the cylinder head gasket is fowled by one single metal layer 1 which contains several through openings 2 functioning as combustion chamber through openings. The profile elements 3, which are connected firmly with the layer 1, can be identified. The same conditions as those provided for FIGS. 1 to 4 are valid. All hatched sections of the layer 1 are built by material compressions 10. It can be seen that not only the immediate area around the corresponding profile element 3, but also the hinterland extended up to the edge areas 11 of the layer 1 is provided in a targeted way with the material compression 10.

FIG. 6 shows a cross section along the A-A line of FIG. 5. The profile element 3, which is designed in the form of a banana, as well as the section b of the material compression 10 present, which is build at this location by means of a double-side embossing, can be identified.

1. A flat gasket comprising at least one layer provided with at least one through opening, whereby the through opening receives at least one elastically malleable profile element built as a profile wire with a ring form and defined material thickness, whereby the full height of the undeformed profile element exceeds the thickness of the layer, and the layer is provided at least partially with material compression in the area of the profile element and/or outside of the profile element.

2. A flat gasket according to claim 1 wherein the material compression is formed by a single- or double-side embossing of the layer.

3. A flat gasket according to claim 1 the material compression is formed by a coating of the layer.

4. A flat gasket according to claim 1 wherein the respective material compression encloses the profile element.

5. A flat gasket according to claim 1 wherein the respective material compression is provided at least also in the edge areas of the layer.

6. A flat gasket according to claims 3 wherein the coating comprises a polymer.

7. A flat gasket according to claim 6 wherein particles or fibers are included in the coating.

8. A flat gasket according to claim 6 wherein the coating contains metal and/or ceramic and/or mineral particles or fibers with thickness that can be specified.

9. A flat gasket according to claim 6 wherein the coating is applied on the corresponding section of the layer by screen printing.

10. A flat gasket according to claim 1 wherein the material compression comprises a stopper.

11. A flat gasket according to claim 1 wherein the material compression sets up defined topographies.

12. A flat gasket according to claim 1 wherein the material compression surrounds the through opening essentially in its entire surface in a defined radial area.

13. A flat gasket according to claim 1 wherein the profile element is built, seen in radial direction, with areas with different material thickness.

14. A flat gasket according to claim 1 wherein the profile element is built, seen in radial direction, with the contour of a banana.

15. A flat gasket according to claim 1 wherein the profile element is built as an open or closed ring.

16. A flat gasket according to claim 1 wherein the profile element is connected with the layer at least partially.

17. A flat gasket according to claim 1 wherein the profile element can move radially within the through opening.

18. A flat gasket according to claim 2 wherein the layer is built of metal which is provided with single-side or double-site plating.

19. A flat gasket according to claim 18 wherein the embossing is provided in at least one of the plated areas.

20. The flat gasket of claim 1, comprising a cylinder head gasket or an exhaust flange gasket.

21. The flat gasket of claim 5, wherein the edge areas comprise bolt through openings.

22. The flat gasket of claim 16 wherein the profile element is form locked with the layer.

23. The flat gasket of claim 18 wherein the plating comprises aluminum or an aluminum alloy.
